(19) United States
(12) Patent Application Publication
(10) Pub. No.: US 2026/0014532 A1
(43) Pub. Date: Jan. 15, 2026

(54) FOAM DISPENSER WITH REMOVABLE CUP

(71) Applicant: STARBUCKS CORPORATION, Seattle, WA (US)

(72) Inventors: Rob Vanderhenst, Culver City, CA (US); Kaylie Clemenza, Redondo Beach, CA (US); Megan Elizabeth Droz, Bothell, WA (US); Jason Nabil Javid, Seattle, WA (US)

(73) Assignee: STARBUCKS CORPORATION, Seattle, WA (US)

(21) Appl. No.: 19/231,866

(22) Filed: Jun. 9, 2025

Related U.S. Application Data
(60) Provisional application No. 63/668,849, filed on Jul. 9, 2024.

(51) Int. Cl. B01F 23/235; B01F 33/501; B01F 35/42; B01F 35/75; B01F 101/06

(52) U.S. Cl. CPC B01F 23/235; B01F 33/50111; B01F 35/421; B01F 35/75425; B01F 2101/06

(57) ABSTRACT

A foam dispenser may include a container having an interior for storing a liquid, a pumping device positioned in the container for converting the liquid into a foam, and a removable cup. The cup may include an interior to hold the foam, a primary opening for pouring the foam from the cup, and an inlet that is separate from the primary opening. The inlet can be attached to the pumping device during operation of the foam dispenser to receive the foam from the pumping device into the cup. The cup can be detached from the pumping device when the foam dispenser is not in use.

### CROSS-REFERENCE TO RELATED APPLICATION

This claims priority under 35 U.S.C. § 119 (e) to U.S. Provisional Application No. 63/668,849, titled “FOAM DISPENSER WITH REMOVABLE CUP” and filed Jul. 9, 2024, the entirety of which is hereby incorporated by reference herein.

### TECHNICAL FIELD

The present disclosure relates generally to foam dispensers. More specifically, but not by way of limitation, this disclosure relates to a foam dispenser that dispenses foam, such as an edible foam, into a removable cup.

### BACKGROUND

Liquid and foam dispensers are commonly used for dispensing soaps and beauty products. Such foam dispensers may include a container for liquid and an air chamber to inject air into the liquid to convert it to foam. Such foams are normally dispensed into the user's hands, for example so that the user can apply the foam to their face or other body part.

### BRIEF DESCRIPTION OF THE DRAWINGS

FIGS. 1A-D show an example of operating a foam dispenser according to some aspects of the present disclosure.

FIG. 2 shows an example of a pumping device according to some aspects of the present disclosure.

FIG. 3 shows an example of enabling a pumping device of a foam dispenser according to some aspects of the present disclosure.

FIG. 4 shows an example of disabling a pumping device of a foam dispenser according to some aspects of the present disclosure.

FIG. 5 shows an example of a replaceable cartridge for a foam dispenser according to some aspects of the present disclosure.

### DETAILED DESCRIPTION

Certain aspects and features of the present disclosure relate to a foam dispenser with a removable cup into which the foam is dispensed during operation of the foam dispenser. When the foam dispenser is not in use, the removable cup can be oriented in a first direction in which it serves as a cap, which can prevent spillage and/or create an air seal that may help preserve the contents of the foam dispenser. When a user wants to operate the foam dispenser, the user can remove the cup from the foam dispenser, rotate the cup so that is facing in a second direction, and couple an inlet of the cup to a pumping device of the foam dispenser. For example, the cup may include an inlet, which may have a threaded connection. The inlet may also include a porous member, such as a mesh. The user may use the threaded connection to screw the inlet, and thus the cup, onto a telescopic straw of the pumping device, thereby establishing fluid communication between the pumping device and the inlet of the cup. After the cup has been attached to the pumping device, the user can activate the pumping device by pushing down on the cup. This downward force can be transferred through the telescopic straw to the pumping device, which can cause the pumping device to generate the foam from a liquid in a container of the foam dispenser. Pressure from the pumping action can push the foam through the telescopic straw and porous member, and finally into the cup. The foam may then be poured from the cup, for example, onto a beverage if the foam is an edible foam made from edible ingredients.

In some examples, the user can attach one or more interchangeable cartridges to the pumping device to change the visual, olfactory, and/or taste characteristics of the foam. For example, the user can removably couple a cartridge between the pumping device and the inlet of the cup, so that foam can be transmitted through the cartridge before entering the cup. The cartridge may contain one or more modifiers that change the look, taste, texture, and/or smell of the foam. Once the contents of the cartridge are depleted, the cartridge can be removed and refilled for reuse (or disposed of).

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

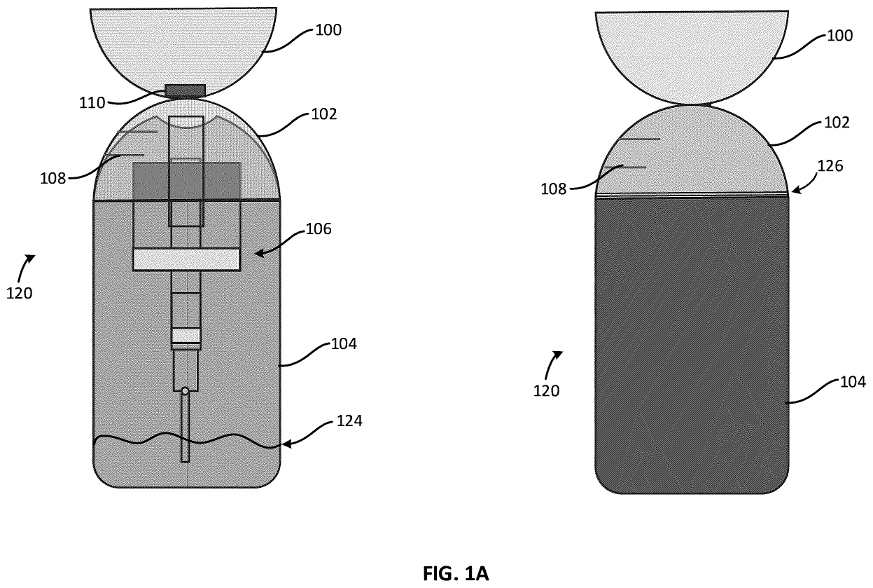

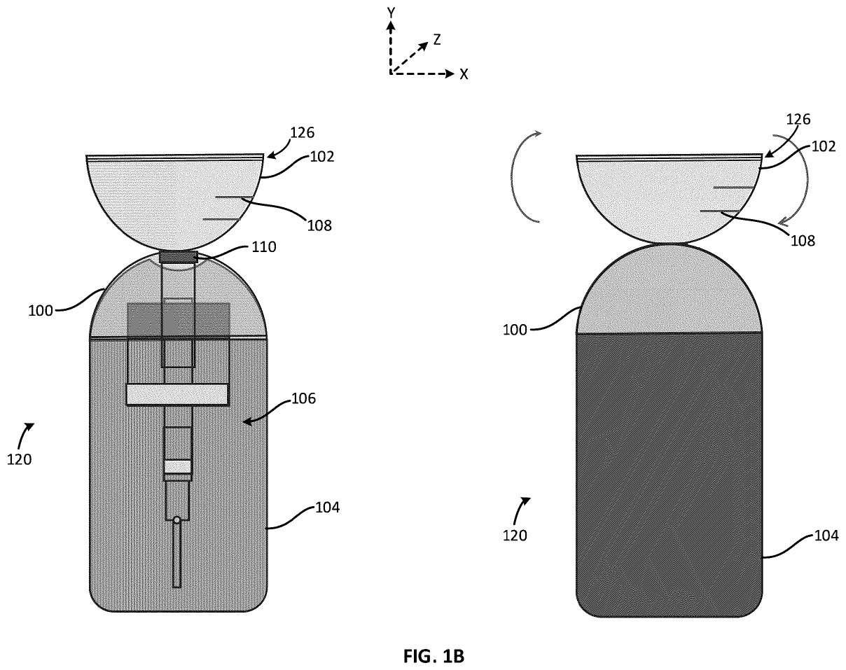

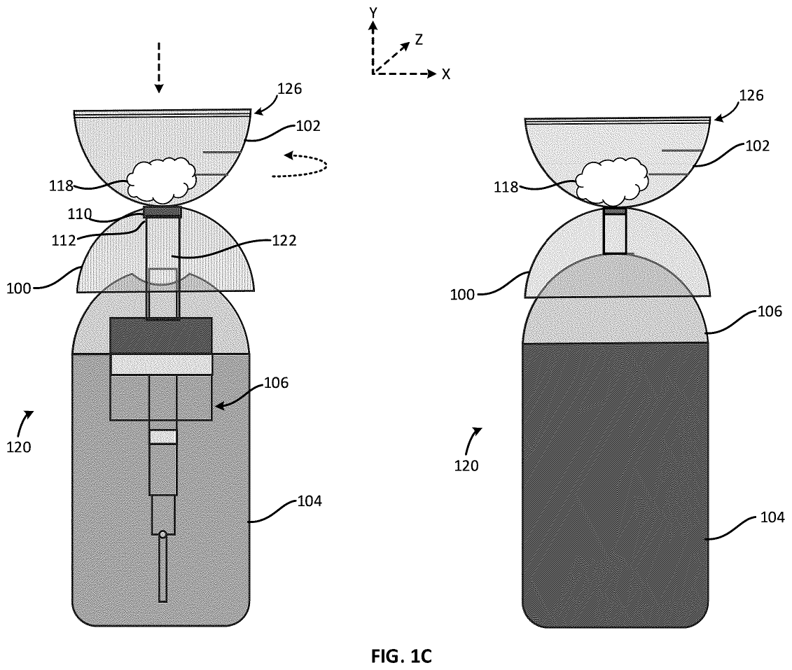

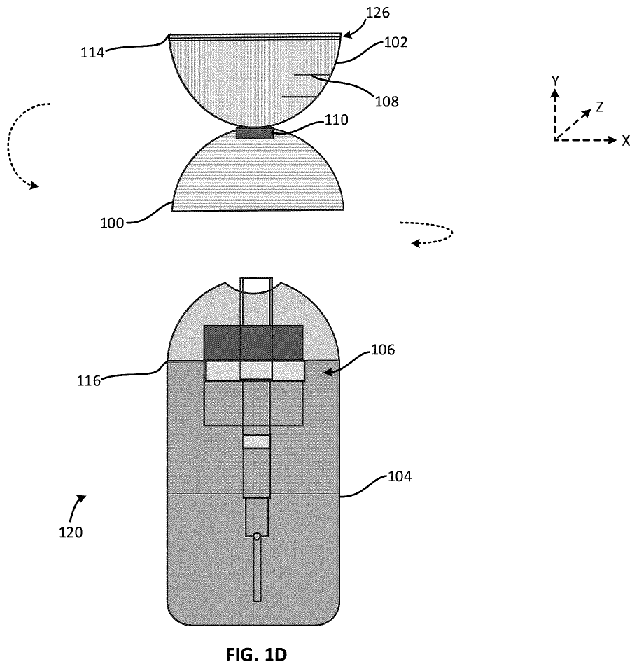

FIGS. 1A-D show an example of operating a foam dispenser 120 according to some aspects of the present disclosure. In particular, the lefthand side of FIG. 1A, shown is a cross-sectional view of the foam dispenser 120 in a first state, which can be considered a closed state. The foam dispenser 120 includes a container 104, which houses a liquid 124 to be converted into a foam. The foam dispenser 120 also includes a pumping device 106 and a cup 102. In the first state, the cup 102 of the foam dispenser 120 can be inverted and positioned overtop of the foam dispenser, such that an interior of the cup 102 serves as a cap for the foam dispenser. The cup 102 may be attached to the container 104 by friction, a threaded connection 126, or any other suitable attachment mechanism in the first state. This may help prevent spillage and create an air seal that helps preserve the contents of the foam dispenser 120.

The cup 102 can have an interior surface and an exterior surface. The cup may be a concave receptacle and thus may be dome shaped. The cup 102 can have a primary opening defined by its rim. A “primary opening” of a component can be the largest diameter opening of the component. An inner diameter at of the rim can be the same size as, or larger than, the outer diameter of the container 104, so that the cup 102 can be mated with the container 104 (e.g., using any of the attachment mechanisms described above) in the first state. The cup 102 may include measuring lines 108 to help measure foam therein.

The pumping device 106 can extend into the liquid 124 and, when operated, convert the liquid 124 into foam. As will be described in greater detail below, the pumping device 106 can include a dip stick, dosing chamber, air chamber, piston system, etc. When the foam dispenser 120 is in the first state, the pumping device 106 can be disabled to prevent spillage.

In some examples, a cover 100 can be attached to the cup 102, though other examples may exclude the cover 100. The cover 100 can help protect the components of the foam dispenser 120 during operation. The cover 100 has an interior surface and an exterior surface. The cover 100 may also be a concave receptacle and thus may be dome shaped. Alternatively, the cover 100 may have any other suitable shape, such as a square shape. The cover 100 can have a primary opening defined by its rim. When the foam dispenser is in the first state, the cover 100 may be facing in an opposite direction to the cup 102. For example, the primary opening of the cover 100 can face in a first direction that is opposite to a second direction of the primary opening of the cup 102. The cover 100 may have an inner diameter at its primary opening that is the same size as, or larger than, the outer diameter of the container 104.

The cover 100 may be coupled to the cup 102 such that the cover 100 and the cup 102 share a common central axis. For example, a bottom portion of the cover 100 can be coupled to a bottom portion of the cup 102, such that the combination of the two creates an hourglass shape having the same central axis. As used herein, the primary opening of the cover 100 or cup 102 is considered the top end, with the opposite end being considered the bottom end. As shown in FIG. 1, the primary opening of the cover 100 can be in a first two-dimensional plane and the primary opening of the cup 102 can be in a second two-dimensional plane, where the first two-dimensional plane is substantially parallel to and spaced apart from the second two-dimensional plane.

The cup 102 can include an inlet for receiving foam from the pumping device 106. In some examples, the inlet can extend between cover 100 and the cup 102, to allow fluid flow through the cover 100 and into the cup 102 during the operation of the foam dispenser 120. For example, an inlet can extend between a bottom portion of the cover 100 and a bottom portion of the cup 102. A porous member 110, such as a mesh, can be fixed to the inlet, so that foam is flowed through the porous member 110 before entering the cup 102 through the inlet.

The righthand side of FIG. 1A shows a perspective view of the foam dispenser 120 in the first state. As shown, from the outside, the cup 102, cover 100, container 104, and measurement lines 108 may be visible. Of course, other examples may exclude the measurement lines 108 and/or may have different visual features to aid in using the foam dispenser 120.

Turning now to FIG. 1B, shown is an example of a first part of a process for activating the foam dispenser 120. In particular, the lefthand side of FIG. 1B shows a cross-sectional view of the foam dispenser 120 in a second state. To transition from the first state to the second state, a user may remove the cup 102 (e.g., the cup/cover combination) from the container 104, for example by unscrewing a threaded connection between the rim of the cup 102 and the container 104. The user may then flip over the cup 102 (e.g., invert the cup 102 in the X-Y plane), as represented by the arrows in the figure, so that the cup 102 is now facing in the first direction. In examples that involve the cover 100, the cover 100 may now be facing in the second direction.

Next, the user can attach the porous member 110 to the pumping device 106. For example, the porous member 110 and the pumping device 106 (e.g., a straw thereof) may have threads configured to mate with one another to establish a fluid connection when rotated in a first rotation direction. The first rotation direction may be in the X-Z plane, which can be perpendicular to the X-Y plane. In this way, the porous member 110 can be removably coupled to the pumping device 106 so that foam created by the pumping device 106 can be pushed through the porous member 110 and into the cup 102 during operation of the foam dispenser 120.

The righthand side of FIG. 1B shows a perspective view of the foam dispenser 120 in the second state. As shown, from the outside, the cup 102, cover 100, container 104, and measurement lines 108 may be visible. But as noted above, some other examples may exclude the cover 100 or other elements.

Turning now to FIG. 1C, shown is an example of a second part of a process for activating the foam dispenser 120. In particular, the lefthand side of FIG. 1C shows a cross-sectional view of the foam dispenser 120 in a third state. To transition from the second state to the third state, in some examples the user may further rotate the cup 102 (e.g., the cup/cover combination) in the first rotation direction, as represented by the curved arrow in FIG. 1C. With the porous member 110 attached to the pumping device 106, this additional rotation may rotate a piston system of the pumping device 106 in a sufficient amount to release a latch that enables the pumping device 106. For example, the additional rotation may release a latch that triggers a spring-loaded telescopic straw 122 of the pumping device 106 to expand and thereby establish fluid communication through the pumping device 106. The foam dispenser 120 may now be ready for pumping.

To pump the foam dispenser 120, the user may push down on the cup 102. For example, the user may push down on the cup 102 in the Y-direction along a central axis of the foam dispenser 120, as shown by a dashed arrow in FIG. 1C. This downward force can translate down through the cup 102 and the telescopic straw 122 in a pumping action that actives the pumping device 106 to create foam 118, which is then transmitted up through the straw 122 and the porous member 110 into the cup 102. During the pumping action, the spring associated with the telescopic straw 122 can be compressed in the Y-direction by the force and, when the force is released, can expand to reset the pumping device 106 for the next pump.

The righthand side of FIG. 1C shows a perspective view of the foam dispenser 120 in the third state. As shown, from the outside, the cup 102, cover 100, container 104, and measurement lines 108 may be visible.

Turning now to FIG. 1D, shown is an example of a process for deactivating the foam dispenser 120. In particular, the lefthand side of FIG. 1D shows a cross-sectional view of the foam dispenser 120 in a fourth state. To transition from the third state to the fourth state, in some examples the user may rotate the cup 102 (e.g., the cup/cover combination) in a second rotation direction, as represented by a curved arrow in FIG. 1D. The second rotation direction can be opposite to the first rotation direction in the X-Z plane. With the porous member 110 attached to the pumping device 106, this rotation of the piston system may compress the telescopic straw 122 and engage a latch, which disables the pumping device 106. For example, the rotation may compress the spring-loaded telescopic straw 122 and engage a latch of the pumping device 106, thereby severing fluid communication through the pumping device 106 and deactivating the foam dispenser 120.

Further rotation of the cup 102 in the second rotation direction may detach the porous member 110 from the pumping device 106, so that the cup 102 (e.g., the cup/cover combination) can be completely separated from the container 104. This may allow the cup 102 to be more easily cleaned than if it was attached to the container 104.

The user may next flip over the cup 102, for example by inverting the cup 102 in the X-Y plane as represented by another curved arrow in FIG. 1D. The user can then attach the cup 102 to the container 104. For example, an upper portion of the cup 102 (e.g., its rim) can be attached to an upper portion of the container 104. This may involve screwing threads on the rim of the cup 102 onto corresponding threads of the container 104. At this point, the foam dispenser 120 may once again be in the first state.

Through the process described above, the foam dispenser 120 can be activated and deactivated by rotating the cup 102 in opposite directions. The foam dispenser 120 can also be pumped by pushing down on the cup 102 in a direction perpendicular to the plane of rotation.

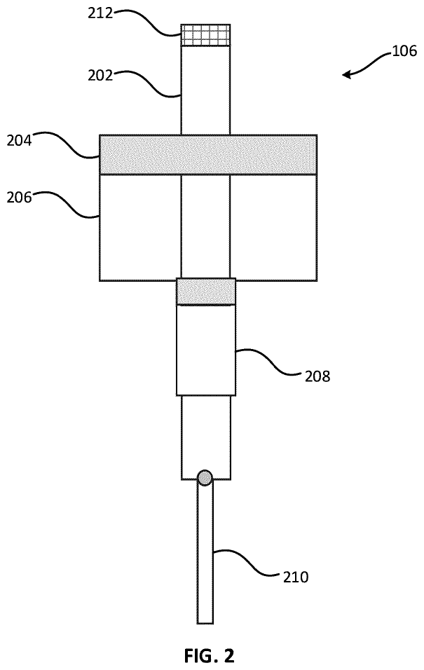

It will be appreciated that although the porous member 110 is fixed to the cup 102 in FIGS. 1A-D, in other examples the porous member 110 may be fixed to the straw 122. In those examples, the cup 102 can include an attachment mechanism that allows its inlet to be removably coupled to the porous member 110. For instance, the inlet of the cup 102 may include a threaded connector that is configured to mate with corresponding threads of the porous member 110, which can be fixed to the end of the straw 122. The remaining functionality of the foam dispenser 120 may remain the same. One such example in which the porous member 110 is fixed to the end of the straw 122 is shown in FIG. 2, which is described below. In still other examples, the foam dispenser 120 may include multiple porous members, which can have the same or different characteristics as one another. For instance, a first porous member may be fixed to the cup 102 and a second porous member may be fixed to the pumping device 106 (e.g., the straw 122). The first porous member may include a different material, or have a different thickness, than the second porous member. The two porous members may include attachment mechanisms, such as threaded connectors configured to mate with each other, so that the porous members can be removably coupled together.

Referring now to FIG. 2, shown is an example of a pumping device 106 according to some aspects of the present disclosure. The pumping device can include a dip tube 210 configured to extend into the liquid in the container of the foam dispenser. The dip tube 210 can be fluidically coupled to a dosing chamber 208, which can be configured to receive a predetermined volume of the liquid. The dosing chamber 208 can be fluidically coupled to an air chamber 206. The air chamber 206 can mix the liquid from the dosing chamber 208 with air to create a foam. The air chamber 206 can include an air intake port for introducing air into the chamber, an inlet port for receiving the liquid from the dosing chamber 208, and an outlet port through which the foam is dispensed. The air chamber 206 can be fluidically coupled to a piston system 204. When operated, the piston system 204 pump air through the air intake port of the air chamber 206 to create the foam and push it upwards through a straw 202 (e.g., telescopic straw 122 of FIG. 1). The straw 202 can be fluidically coupled to a porous member 212 (e.g., porous member 110) during usage of the foam dispenser. The foam can be pumped upwards through the straw 202 and the porous member 212 before entering the cup of the foam dispenser.

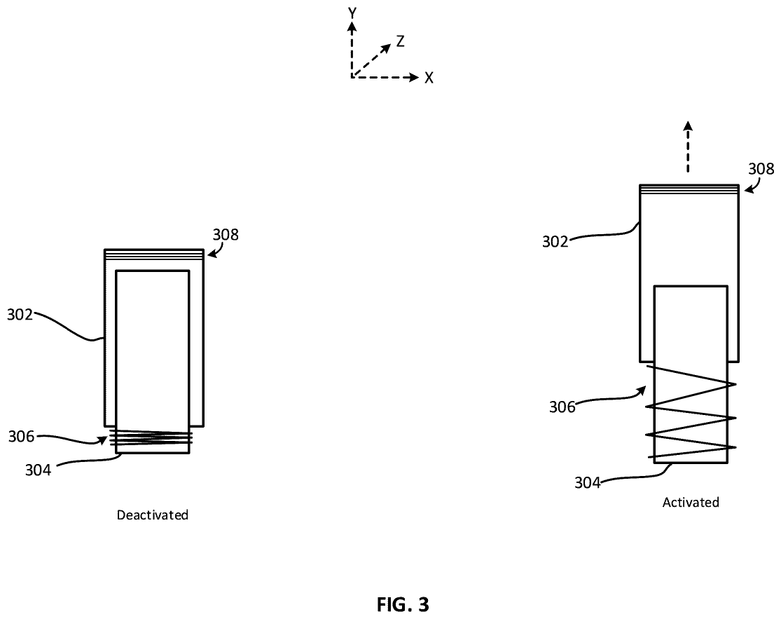

FIG. 3 shows an example of enabling a pumping device of a foam dispenser according to some aspects of the present disclosure. The lefthand side of the figure shows a telescopic straw 302 (e.g., straw 122 of FIG. 1) of the pumping device in a deactivated state, in which a spring 306 is compressed. In the deactivated state, the telescopic straw 302 is fluidically disengaged from a pumping portion 304 of the pumping device. This prevents fluid flow between the telescopic straw 302 and a remainder of the pumping device. Conversely, the righthand side of the figure shows the telescopic straw 302 of the pumping device in an activated state, in which a spring 306 is expanded. This pushes the telescopic straw 302 upwards along the Y-axis such that it fluidically engages with a pumping portion 304 of the pumping device, establishing a fluid connection between the two.

In some examples, the pumping device may be transitioned from the deactivated state to the activated state by rotating the telescopic straw 302 in a first rotation direction (e.g., counterclockwise). As described earlier, the telescopic straw 302 may include threads 308 or another attachment mechanism for removably coupling with a porous member, which in turn may be affixed to a cup. Thus, rotating the cup in the first rotation direction can also rotate porous member and the telescopic straw 302 in the first rotation direction, which can activate the pumping device.

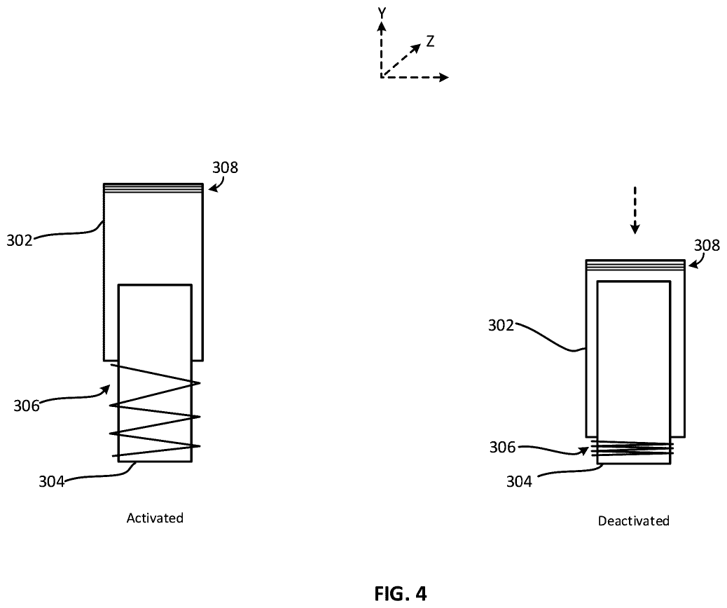

Rotating the cup in the opposite direction can have the opposite effect and disable the pumping device, as shown in FIG. 4. In particular, as shown, the pumping device may be transitioned from the activated state to the deactivated state by rotating the telescopic straw 302 in a second rotation direction (e.g., clockwise) that is opposite to the first rotation direction. Rotating the cup in the second rotation direction can also rotate porous member and the telescopic straw 302 in the second rotation direction, which can deactivate the pumping device.

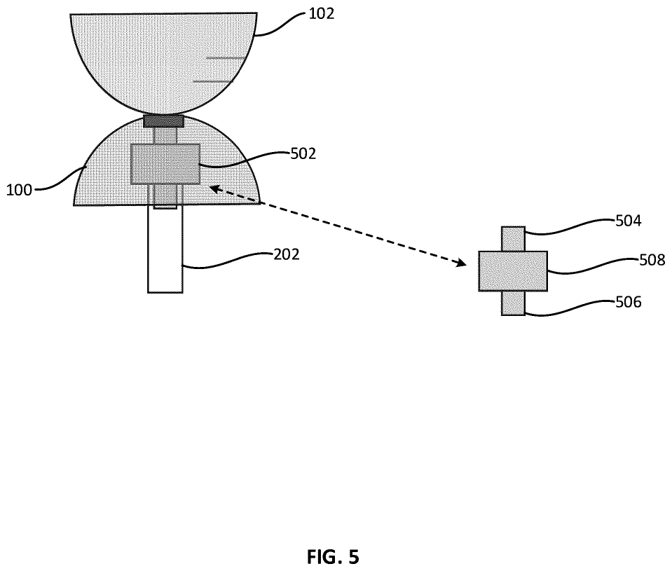

FIG. 5 shows an example of a replaceable cartridge 502 for a foam dispenser according to some aspects of the present disclosure. The replaceable cartridge 502 can be configured to be positioned between the pumping device (a component thereof, such as the straw 202) and the inlet of the cup 102. The replaceable cartridge 502 can include one or more modifiers that change one or more characteristics of the foam. Example of such characteristics can include a color, texture, smell, favor, viscosity, and/or pattern of the foam. For instance, the replaceable cartridge 502 can include glitter, food coloring, a flavoring (e.g., vanilla extract), a thinning agent, a thickening agent, a solid food ingredient such as crushed cookies or nuts, or any combination of these.

The replaceable cartridge 502 can include an inlet 506 to receive the foam from the pumping device. The replaceable cartridge 502 can also include an outlet 504 to provide the modified foam to the cup. Within the replaceable cartridge 502 can be a mixing chamber for mixing the one or more modifiers with the foam to produce the modified foam.

The replaceable cartridge 502 can include a first coupling device configured to fluidically couple its inlet 506 to the pumping device for receiving the foam. For instance, the first coupling device can include threads or any other suitable attachment mechanism to fluidically couple its inlet 506 to the straw 202 of the pumping device. The replaceable cartridge 502 can also include a second coupling device configured to fluidically couple its outlet 504 to the inlet of the cup. For instance, the second coupling device can include threads or any other suitable attachment mechanism to fluidically couple its outlet 504 to the inlet of the cup (e.g., through the porous member).

The replaceable cartridges can be interchangeable with one another. And, in some examples, multiple replaceable cartridges can be attached to the foam dispenser to modify the foam as desired. For example, two or more replaceable cartridges may be simultaneously attached to the foam dispenser in series with one another. This may allow for multiple different modifiers, or more of a single modifier, to be injected into the foam.

In some examples, the foam dispensed by the foam dispenser may be an edible foam. An edible foam can be a foam designed for human consumption. One example of such an edible foam can be a cold foam. A “cold foam” can be a foam that is produced from a liquid base (e.g., a dairy or non-dairy liquid base) that is maintained at a temperature of 100° F. or less during the foaming process. If the liquid base is heated to a temperature of more than 100° F. during the foaming process, the resulting foam may be referred to as a “warm” or “hot” foam. The cold foam can be used to top a beverage product, such as coffee. If the foam is an edible foam, the modifiers injected into the foam by the replaceable cartridge 502 would also include edible ingredients.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

1. A foam dispenser, comprising:
a container having an interior for storing a liquid;
a pumping device configured to be positioned in the container, the pumping device including:
a dip tube configured to extend into the container;
a dosing chamber coupled to the dip tube;
an air chamber coupled to the dosing chamber, the air chamber being configured to inject air into the liquid to generate a foam;
a straw coupled to the air chamber; and
a piston coupled to the straw, the piston being operable to pump the foam from the air chamber through the straw; and
a cup including:
an interior configured to hold the foam;
a primary opening for pouring the foam from the cup; and
an inlet that is separate from the primary opening, the inlet being configured to be coupled to the pumping device during operation of the foam dispenser.

2. The foam dispenser of claim 1, wherein the inlet is coupled to a porous member, the porous member being configured to be coupled between the straw and the cup during operation of the foam dispenser, such that the foam flows through the porous member before entering the cup during the operation of the foam dispenser.

3. The foam dispenser of claim 2, wherein the porous member is a mesh device configured to screw onto a top end of the straw for connecting the cup to the pumping device.

4. The foam dispenser of claim 2, wherein the cup is configured to attach to the pumping device through first rotation of the cup in a first direction, wherein the first rotation in the first direction is also configured to enable the pumping device.

5. The foam dispenser of claim 4, wherein the cup is configured to detach from the pumping device through second rotation of the cup in a second direction, wherein the second rotation in the second direction is also configured to disable the pumping device.

6. The foam dispenser of claim 1, wherein a rim of the cup is configured to be attached to an upper portion of the container when the foam dispenser is not in use.

7. The foam dispenser of claim 1, further comprising a replaceable cartridge that is configured to be positioned between a part of the pumping device and the inlet of the cup, wherein the replaceable cartridge is includes at least one modifier that changes at least one characteristic of the foam.

8. The foam dispenser of claim 7, wherein the at least one characteristic includes a color, texture, smell, favor, viscosity, and/or pattern of the foam.

9. A method of using a foam dispenser, the method comprising:
detaching a cup from the foam dispenser, the cup including:
an interior for holding foam dispensed from the foam dispenser;
a primary opening for pouring the foam from the cup;
an inlet that is different from the primary opening; and
attaching the inlet directly or indirectly to a pumping device of the foam dispenser; and
pressing on the cup to activate the pumping device, wherein upon activation the pumping device converts liquid in a container of the foam dispenser into the foam and dispenses the foam into the cup.

10. The method of claim 9, wherein the cup further comprises a porous member, and wherein attaching the inlet to the pumping device involves screwing the porous member onto a straw of the pumping device.

11. The method of claim 9, wherein detaching the cup involves unscrewing an upper portion of the cup from an upper portion of the container.

12. The method of claim 9, wherein the interior of the cup is oriented in a first direction when the cup is attached to the foam dispenser, and wherein the interior of the cup is oriented in a second direction when the inlet is attached to the pumping device, the second direction being opposite to the first direction.

13. The method of claim 9, further comprising:
detaching the inlet from the pumping device; and
attaching the cup to the foam dispenser.

14. The method of claim 13, wherein attaching the cup to the foam dispenser involves screwing an upper portion of the cup to an upper portion of the container.

15. The method of claim 9, further comprising positioning a replaceable cartridge in a flow path between the pumping device and the inlet of the cup, wherein the replaceable cartridge includes at least one modifier that changes at least one characteristic of the foam.

16. The method of claim 15, further comprising activating the replaceable cartridge to change the at least one characteristic of the foam.

17. The method of claim 15, wherein the at least one characteristic includes a color, texture, smell, favor, viscosity, and/or pattern of the foam.

18. The method of claim 9, wherein the inlet is in a first two-dimensional plane and the primary opening is in a second two-dimensional plane that is substantially parallel to and spaced apart from the first two-dimensional plane, and wherein the inlet and the primary opening are positioned at opposite ends of the cup, the inlet being at a bottom end of the cup and the primary opening being at a top end of the cup.

19. A cup for a foam dispenser, the cup comprising:
an interior for holding foam dispensed from the foam dispenser;
a primary opening for pouring the foam from the cup; and
an inlet configured to receive the foam dispensed from a dispensing device of the foam dispenser during operation of the foam dispenser, the inlet being different from the primary opening.

20. The cup of claim 19, wherein a rim of the cup is configured to be attached to and contact an outer wall of the foam dispenser when the foam dispenser is not in use.
